(19) United States
(12) Patent Application Publication
(10) Pub. No.: US 2010/0268389 A1
(43) Pub. Date: Oct. 21, 2010

(54) SYSTEM AND METHOD FOR REGULATING A FLOW OF LIQUID

(75) Inventor: Frank-Hendrik Wurm, Dortmund (DE)

Correspondence Address: KF ROSS PC, 5683 RIVERDALE AVENUE, SUITE 203 BOX 900, BRONX, NY, 10471-0900, US

(73) Assignee: WILO SE, Dortmund (DE)

(21) Appl. No.: 12/740,754

(22) PCT Filed: Nov. 10, 2008
(86) PCT No.: PCT/EP2008/009460

§ 371 Date: May 12, 2010

(30) Foreign Application Priority Data
Nov. 9, 2007 (DE) 10 2007 053 948.9

(51) Int. Cl. G05D 7/06; F15D 1/00

(52) U.S. Cl. 700/282; 137/565.01

(57) ABSTRACT

The invention relates to a system and to a method for regulating a flow of liquid in a line, with a pump delivering the liquid to the consumer, tank or process. In particular, the invention relates to a sewage disposal system for public disposal of sewage, with a sewage pipe network comprising a plurality of sewage lines, and with at least one motor-driven pump delivering sewage through the sewage lines to a settling tank, to a service water support system for public supply of water, with a water supply pipe network comprising a plurality of water supply lines and with at least one motor-driven pump delivering service water through the water supply lines to a consumer, and to a liquid delivery system for providing a chemical liquid in a process, with a liquid pipe network comprising a plurality of pipelines and with at least one motor-driven pump delivering the chemical liquid into the process.

The invention relates to a system for and a method of controlling a liquid flow in a line, with a pump delivering the liquid to a consumer, tank, or process.

In particular, the invention relates to a sewage disposal system for public sewage disposal, with a sewage pipe network consisting of a plurality of sewage lines and with at least one motor-driven pump delivering sewage through the sewages lines to a settling tank, a tap water supply system for public water supply with a water-supply pipe network consisting of a plurality of water-supply lines and with at least one motor-driven pump delivering tap water through the water-supply lines to a consumer, and a liquid-delivery system for providing a chemical liquid in a process with a liquid pipe network and with at least one motor-driven pump delivering the chemical liquid into the process.

In systems in which a liquid is delivered by a pump to a plurality of consumers, it is often required that all consumers receive a certain amount of liquid, in particular an amount of liquid depending on need, to supply the process or the energy distribution. However, in systems that are not regulated, the consumers closer to the pumps receive more liquid than consumers located further away. To resolve this, it is known to insert a throttle element for controlling the liquid to be delivered or for controlling the amount of liquid into each line running to the respective consumer and, furthermore, to use stronger pumps that work against the more or less closed throttle elements. This results in high energy consumption and flow noise.

For quite some time work is being done to reduce these problems by integrating in the lines sensors that measure the process parameters therein, in particular pressures and/or flows. With these values, the valves are regulated via electronic controls. Here, controlling is comparatively complicated because a sufficient stability in the liquid system must be achieved and oscillation must be prevented. Also, the above mentioned throttle losses are not allowed to occur.

It is the object of the invention to provide a system and a method of the type described above with a high operating efficiency without having the above-mentioned problems, in particular the losses of the throttle element. In addition, it is the object of the invention to achieve a need-based supply to the processes and system components so that the energy demand of the pumps can be significantly reduced.

This object is attained according to the invention in that instead of a liquid control or throttling element provided within the line, such as a valve, a shutoff, a flap gate or a slide valve, throughput of the pump is controlled according to need and no further controlling or throttle element for controlling the pump flow rate is provided in the lines.

For the technical field of the public sewage disposal, therefore, a sewage disposal system is proposed with a sewage pipe network consisting of a plurality of sewage lines and with at least one motor-driven pump delivering sewage through the lines to a settling tank or sedimentation tank, where instead of the slide valves provided in the sewage lines for controlling sewage flow, throughput of the pump is controlled according to need and, in particular, no further control or throttling element for controlling the throughput is provided in the sewage lines. The basic idea of this technical teaching is to replace the slide valves that, according to the prior art, control the sewage flow through the lines in the sewage disposal system, the pump is controlled, in particular with respect to its speed, to regulate delivery of the sewage. For an operating condition of the sewage system with a slide valve halfway closed, this slide valve can be replaced by the fact that the pump adjusts itself automatically or is adjusted to half of its capacity or speed or, to maintain a certain adjusting reserve, to slightly less than half of its capacity. If a slide valve of a sewage system of the prior art is closed, this operating condition can be achieved according to the invention by automatically shutting down the pump or adjusting the pump to a minimum of its capacity or speed. This has the advantage that the pump does not have to work against one or more closed slide valves. In particular, the slide valves can be replaced with speed-controlled pumps. Slide valves can still be provided in a system according to the invention to stop the sewage flow through the lines completely in case of an emergency, but such slide valves are not involved in controlling the pump flow rate or the sewage flow rate through the sewage lines. This is done exclusively by the need-based adjustment of the capacity or speed of the pump.

For the technical field of the public water supply, a water-supply system is proposed with a water-supply pipe network consisting of a plurality of water-supply lines and with at least one motor-driven pump delivering tap water through the water-supply lines to a consumer, where instead of the valves provided in the water-supply lines and controlling the water flow, throughput of the pump is controlled, in particular its speed, and, in particular, no further control or throttling element for controlling the throughput is provided in the water-supply lines. The basic idea of this technical teaching is to replace the valves that, according to the prior art, control the tap water flow through the lines, by the fact that the pump delivering the tap water or generating the pressure in the lines is controlled, in particular with respect to its speed. If a large amount of water is removed from the water-supply system and the water demand is correspondingly high, the pump can work at high throughput, in particular at high speed and, accordingly, can provide high pressure in the line. If, in contrast, a small amount of water is removed, it is sufficient for this operating condition to operate the pump automatically with low capacity or low speed so that it does not work against one or more closed valves. In particular, the valves can be replaced with speed-controlled pumps. For closure of a water line, the tap water-supply system can have a valve, for example in the form of a water tap, or other valves. However, according to the invention, these are not the control elements for controlling the water throughput because, according to the invention, such control is effected by the pump and the pump is the control element. Therefore, such valves are not involved in controlling the pump flow rate or the throughput through the water-supply lines. This is done exclusively by the need-based adjustment of the capacity or speed of the pump.

Furthermore, for the technical field of provision of chemical liquids in processes, a liquid-delivery system is proposed with a liquid pipe network consisting of a plurality of pipelines that, in particular, can also be formed by hoses, and with at least one motor-driven pump delivering the chemical liquid into the process, where instead of valves, shutoffs or flap gates that are provided in the pipelines and that control the delivery volume of the liquid, throughput of the pump is controlled according to need and where in particular no further control or throttling element for controlling the pump flow rate or liquid flow is provided in the pipelines. The basic idea of this technical teaching is again to replace the valves, shutoffs, or flap gates that, according to the prior art, control the throughput through the lines in the delivery system, with a pump whose delivering the chemical liquid and whose throughput controlled, in particular with respect to its speed. In particular, for the operating condition that only 50 percent of a maximum delivery amount of liquid is to be delivered, it is also possible here, instead of a closing a valve halfway, setting the pump adjusts automatically to approximately half of its capacity or speed, or, to maintain a certain adjusting reserve, to slightly less than half of its capacity. If a valve according to the prior art is closed, this operating condition can be achieved according to the invention by automatically shutting down the pump or by adjusting the pump to a minimum of its capacity or speed. This has the advantage that the pump does not have to work against one or more closed valves, shutoffs, or flap gates. In particular, the valves, shutoffs, or flap gates can be replaced by speed-controlled pumps. However, valves, shutoffs, or flap gates can still be provided in a system according to the invention, in particular at the process supply point, to stop the liquid flow through the lines completely in the case of an emergency; however, such valves, shutoffs, or flap gates do not serve to control the pump flow rate or throughput through the pipelines. This is done exclusively by the need-based adjustment of the capacity or speed of the pump.

Replacing the controlling and throttling element with a controlled motor-driven centrifugal pump results in an exact and need-based delivery while requiring the lowest technical effort. While this regulation is easy to implement, the control algorithm of the pump(s) allows a delivery of the amount that is actually needed, with a high stability and without build-up of oscillations and without throttling losses. Exact and predetermined delivery volumes to the consumers, tanks or processes are achieved with low energy consumption and the lowest noises. Here, the teaching according to the invention applies to all types and applications of systems and line systems independent of the liquid that is delivered therein.

It is particularly advantageous when the suction side or pressure side of the pump is directly connected, with or without an intermediate line, to the device(s) in need of the liquid flow, such as the consumer, tank or process.

It is also proposed that upstream or downstream of the pump no control or throttling element is provided in the line. It is further proposed that for each consumer, tank or process, a pump is provided that is allocated to the consumer and that supplies the consumer so that the associated pump always delivers only as much liquid to the consumer, tank or process as needed by the same. Preferably, the pump has at least one display that shows the state of the pump, the heat consumption, the flow temperatures and return temperatures, and/or error messages. Controlling the pump requires a control algorithm that is preferably provided by the pump supplier/manufacturer. It is further of advantage when the pump has an electronic controller. Here, the electronic controller of the pump can be connected with electronic controllers of further pumps and/or a central calculator/computer. Also, all controllers can be connected to a data line, in particular via radio, and each of them can have a controllable address.

A method of controlling the liquid flow in a line with a pump delivering the liquid to the consumer, tank or process is characterized in that instead of a liquid control or throttling element provided in the line such as a valve, a shutoff, a flap gate or a slide valve, the throughput of a motor-driven centrifugal pump is controlled according to the process requirements according to need.

Exemplary are described in more detail below.

A system comprises at least one device requiring a liquid flow such as a consumer, tank or process to which a liquid is to be delivered. The consumer can be, for example, a tank, a line system, a system component or a space in which a chemical or physical process takes place.

The liquid is delivered to the consumer, tank or process through a line in which a motor-driven centrifugal pump is provided that delivers the liquid through the line to the consumer, tank or process. Between the pump and the consumer, tank or process there is no control or throttling element provided in the line so that the pump delivers the liquid unhindered through the line to the consumer, tank or process.

The motor-driven centrifugal pump is electronically controlled with respect to its speed according to the requirements that are given by the consumer, tank, or process. Thus, the pump does not work against a controlled valve that would be partly or completely closed in case of a low demand from the consumer, tank or process, but the pump delivers according to the needs to the consumer, tank or process due to its need-based regulation.

Depending on the application and the demand, one pump is provided for each consumer, tank or process, or one pump delivers to a plurality of consumers, tanks or processes, or a plurality of pumps delivers to a plurality of consumers, tanks or processes. To this ends, the pump is connected with its pressure or suction port directly to the consumer, or a line is provided therebetween.

Preferably, the pump has a display that indicates the state of the pump, the heat consumption, the flow temperature and/or return temperature and/or error messages.

The pump is electronically controlled, the electronic controller can be connected via cable or radio, thus wireless, with electronic controllers of further pumps and/or with a central calculator/computer. All controllers can be connected to one data line, in particular via radio, and each of them can have a controllable address. Further, the pump can be controllable via a wireless electronic remote control.

The controlling algorithm that ensures the control of the pump is included in at least one electronic component of the pump or in a control outside of the pump and is provided by the pump supplier or the pump manufacturer.

1. A sewage disposal system for public sewage disposal, with a sewage pipe network consisting of a plurality of sewage lines, and with at least one motor-driven pump delivering sewage through the sewage line to a settling tank, characterized in that instead of slide valves provided in the sewage lines, the pump is controlled according to need and that, in particular, no further control or throttling element for controlling the pump flow rate is provided in the sewage lines.

2. The sewage disposal system according to claim 1, characterized in that a plurality of motor-driven pumps delivering sewage, in particular one motor-driven pump in each sewage line, is provided in the sewage pipe network, the throughout of all pumps being controlled according to need.

3. A tap water-supply system for public water supply, with a water-supply pipe network consisting of a plurality of water-supply lines and with at least one motor-driven pump delivering tap water through the water-supply lines to a consumer, characterized in that instead of valves provided in the water-supply lines, throughput of the pump is controlled according to need and that, in particular, no further control or throttling element for controlling the pump flow rate is provided in the water-supply lines.

4. The tap water-supply system according to claim 3, characterized in that a plurality of motor-driven pumps delivering tap water, in particular one motor-driven pump in each water-supply line, is provided in the water-supply pipe network, the throughput of all pumps being controlled according to need.

5. A liquid-delivery system for providing a chemical liquid in a process, with a liquid pipe network consisting of a plurality of pipelines and with at least one motor-driven pump delivering the chemical liquid into the process, characterized in that instead of valves, shutoffs or flap gates provided in the pipelines, throughput of the pump is controlled according to need and that, in particular, no further control or throttling element for controlling the pump flow rate is provided in the pipelines.

6. The liquid-delivery system according to claim 5, characterized in that a plurality of motor-driven pumps delivering the chemical liquid, in particular one motor-driven pump in each pipeline, is provided in the liquid pipe network, the throughout of all pumps being controlled according to need.

7. The system according to any one of the preceding claims, characterized in that the speed of the motor-driven pump or motor-driven pumps is controlled.

8. The system according to any one of the preceding claims, characterized in that the suction side or pressure side of the pump is directly connected with or without intermediate line to the consumer, the settling tank or the process.

9. The system according to any one of the preceding claims, characterized in that for each consumer, settling tank or process, a pump is provided that is allocated to the consumer, the settling tank or the process and that supplies to the consumer, the settling tank or the process.

10. The system according to any one of the preceding claims, characterized in that the pump has an electronic controller.

11. The system according to claim 10, characterized in that the electronic controller of the pump is connected via cable or radio with electronic controllers of further pumps and/or with a central calculator/computer.

12. The system according to claim 10 or claim 11, characterized in that all controllers are connected to a data line, in particular via radio, and each of them has a controllable address.

13. The system according to any one of the preceding claims, characterized in that the pump has at least one display that indicates the state of the pump, the heat consumption, the flow temperature and/or return temperature, and/or error messages.

14. A method of controlling public sewage disposal in a sewage disposal system, with a sewage pipe network consisting of a plurality of sewage lines and with at least one motor-driven pump delivering sewage through the sewage lines to a settling tank, characterized in that instead of the slide valves provided in the sewage lines, throughput of the pump is controlled according to need and no further control or throttling element being provided in the sewage lines.

15. A method of controlling the public water supply in a tap water system, with a water-supply pipe network consisting of a plurality of water-supply lines and with at least one motor-driven pump delivering tap water through the tap water lines to a consumer, characterized in that instead of valves provided in the water-supply lines, throughput of the pump is controlled according to need and no further control or throttling element is provided in the water-supply lines.

16. A method of controlling the provision of a chemical liquid in a process within a liquid-delivery system, with a liquid pipe network consisting of a plurality of pipelines, and with at least one motor-driven pump delivering the chemical liquid into the process, characterized in that instead of valves, shutoffs, or flap gates provided in the pipelines, the pump is controlled according to need and that no further control or throttling element is provided in the pipelines.
